(19) United States
(12) Patent Application Publication
(10) Pub. No.: US 2009/0303182 A1
(43) Pub. Date: Dec. 10, 2009

(54) DISCRETE VIBRATION SCROLL WHEEL DEVICE

(75) Inventor: Wen-Hung WU, Taipei Hsien (TW)

Correspondence Address: Muncy, Geissler, Olds & Lowe, PLLC, P.O. BOX 1364, FAIRFAX, VA, 22038-1364, US

(73) Assignee: ZIPPY TECHNOLOGY CORP.

(21) Appl. No.: 12/134,721

(22) Filed: Jun. 6, 2008

(51) Int. Cl. G06F 3/033

(52) U.S. Cl. 345/163

(57) ABSTRACT

The present invention discloses a discrete vibration scroll wheel device, which comprises: a scroll wheel and a support seat supporting the scroll wheel. The scroll wheel has a wheel portion and an axle portion. The support seat has an axle-receiving hole where the axle portion is inserted and held. The axle portion of the scroll wheel has a toothed disc with a plurality of protrusions and recessions arranged alternately. The support seat has a stepping generation member corresponding to the toothed disc. The stepping generation member has a pressing tip normally contacting the toothed disc. The rotation of the scroll wheel makes the pressing tip move to-and-fro between the protrusions and recessions and generates the vertical and reciprocating vibration travels of the pressing tip. Thereby, when the user operates the scroll wheel, he will have a hand feeling of discrete vibrations generated by the stepping generation member.

### FIELD OF THE INVENTION

The present invention relates to a scroll wheel device, particularly to a discrete vibration scroll wheel device.

### BACKGROUND OF THE INVENTION

The mouse is a pointer device widely used in computer systems. The mouse can detect 2-D movement and is very suitable to a GUI (Graphical User Interface) operating system. The traditional mouse has a pointer detecting movement and functional keys generating control signals. The user can control the cursor on the screen via merely moving the mouse and can enter an instruction via pressing the functional key on the mouse. Compared with the keyboard used to input complicated instructions or programming language, the mouse is much more user-friendly.

The user manipulates the traditional mouse via holding and moving it two-dimensionally on a plane. When the user is browsing a large size webpage or document, the manipulation of the mouse is likely to be confined by the space available for the mouse. Thus, some prior arts, such as US patents of U.S. Pat. No. 5,912,661 and No. 6,188,389, additionally adopted a scroll wheel unit, whereby the user can move the contents of the screen along a direction via merely rolling the scroll wheel. Thereby, the efficiency of browsing is effectively promoted. However, the scroll wheel rolled by the user will not stop unless the user applies an opposite-direct force to the scroll wheel. Further, the user cannot learn the exact displacement of the scroll wheel but has to roll the scroll wheel to-and-fro to adjust the position and search for the intended contents. Therefore, some prior arts, such as US patents of U.S. Pat. No. 6,246,392 and No. 6,697,050, additionally installed a stepping device in the circumference of the scroll wheel, which makes the user feel the step points and helps the scroll wheel stop, whereby the user has a better operation feeling. However, the stepping device and scroll wheel unit are dispersively arranged on an electronic substrate. In assembling a mouse, the dispersively-arranged components need aligning, soldering, etc., which make the assembling process of the traditional mouse more complicated and more time-consuming. Further, as the components are not compactly arranged on the electronic substrate, the space-efficiency of the traditional mouse is poor.

### SUMMARY OF THE INVENTION

The primary objective of the present invention is to provide a discrete vibration scroll wheel device, which comprises: a scroll wheel and a support seat supporting the scroll wheel. The scroll wheel has a wheel portion and an axle portion. The support seat has an axle-receiving hole where the axle portion is inserted and held. The axle portion of the scroll wheel has a toothed disc with a plurality of protrusions and recessions arranged alternately. The support seat has a stepping generation member corresponding to the toothed disc. The stepping generation member has a pressing tip normally contacting the toothed disc. The rotation of the scroll wheel makes the pressing tip move to-and-fro between the protrusions and recessions and generates the vertical and reciprocating vibration travels of the pressing tip. The stepping generation member is arranged inside the axle-receiving hole or in another location of the support seat.

In one embodiment of the present invention, the stepping generation member has a ball containing the pressing tip and an elastic member pressing the ball to normally contact the toothed disc. The ball and elastic member are installed inside a holding track.

In another embodiment of the present invention, the stepping generation member is an elastomer having a pressing tip and a fixing portion fixed to the support seat.

The present invention can modularize the scroll wheel device having a stepping function and simplify the assembling process thereof. Further, the present invention can compactly arrange the components of the scroll wheel device and promote the space-efficiency of the mouse.

### BRIEF DESCRIPTION OF THE DRAWINGS

FIG. 1A, FIG. 1B are exploded views schematically showing the structure of a discrete vibration scroll wheel device according to a preferred embodiment of the present invention.

FIG. 2 is a sectional view schematically showing the structure of a discrete vibration scroll wheel device according to a preferred embodiment of the present invention.

FIG. 3 is a diagram schematically showing the discrete vibrations of a discrete vibration scroll wheel device according to a preferred embodiment of the present invention.

FIG. 4 is a diagram schematically showing that the stepping generation member is arranged inside the axle-receiving hole according to a preferred embodiment of the present invention.

FIG. 5 is a diagram schematically showing the discrete vibrations of a discrete vibration scroll wheel device according to another preferred embodiment of the present invention.

### DETAILED DESCRIPTION OF THE PREFERRED EMBODIMENTS

Below, the technical contents of the present invention are described in detail in cooperation with the drawings.

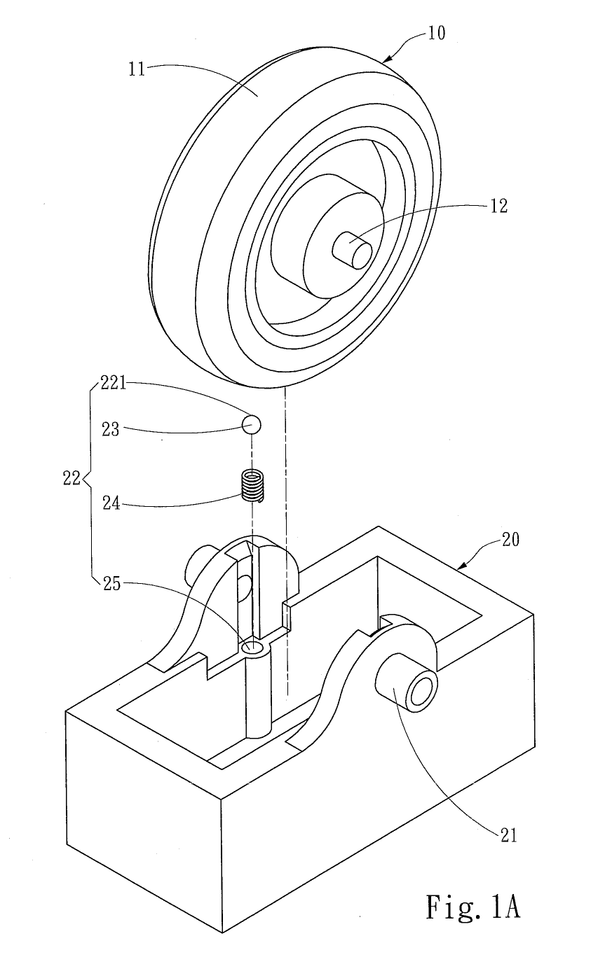

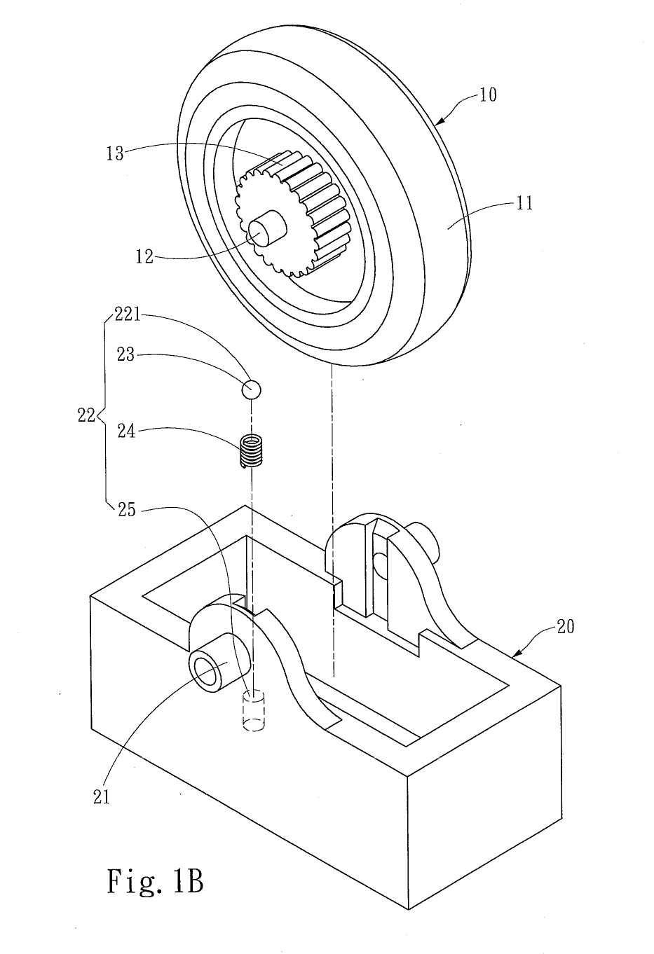

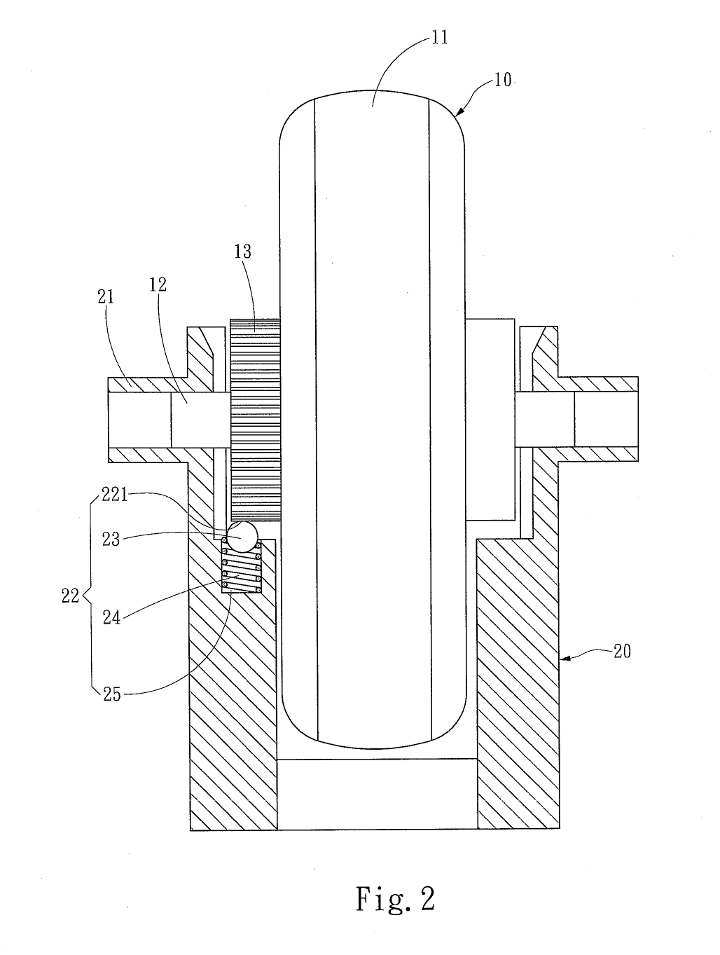

Refer to FIG. 1A, FIG. 1B, and FIG. 2, two exploded views and a sectional view schematically showing the structure according to a preferred embodiment of the present invention. The present invention proposes a discrete vibration scroll wheel device, which comprises: a scroll wheel 10 and a support seat 20 supporting the scroll wheel 10. The scroll wheel 10 has a wheel portion 11 and an axle portion 12. The support seat 20 has an axle-receiving hole 21 where the axle portion 12 is inserted and held. The axle portion 12 of the scroll wheel 10 has a toothed disc 13 with a plurality of protrusions and recessions arranged alternately. The support seat 20 has a stepping generation member 22 corresponding to the toothed disc 13. The stepping generation member 22 has a pressing tip 221 normally contacting the toothed disc 13. When the scroll wheel 10 is rotated by the user, the pressing tip 221 moves to-and-fro between the protrusions and recessions to form the vertical and reciprocating vibration travels of the pressing tip 221.

In this embodiment, the stepping generation member 22 has a ball 23 containing the pressing tip 221 and an elastic member 24 pressing the ball 23 to normally contact the toothed disc 13. The ball 23 and elastic member 24 are installed inside a holding track 25. The elastic member 24 may be a spring, an elastic rubber, or a mechanical elastic device.

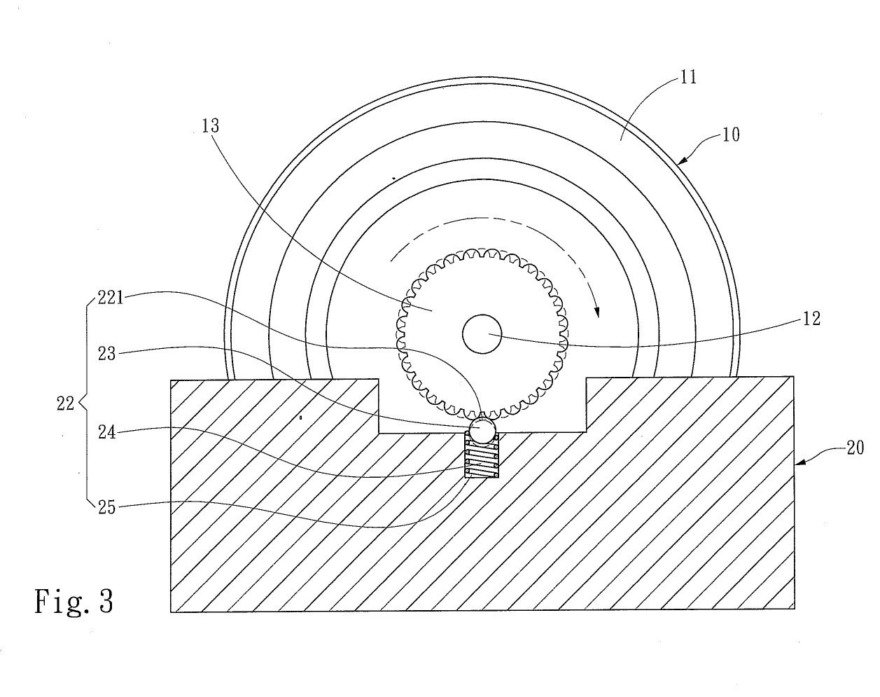

Refer to FIG. 2 and FIG. 3. When the user does not apply any force to the scroll wheel 10, the elastic member 24 presses the ball 23 to normally contact the toothed disc 13. When the user applies a rotational force to the scroll wheel 10, the scroll wheel 10 rotates, and the axle portion 12 drives the toothed disc 13 to rotate also. As the ball 23 normally presses against the toothed disc 13 and is confined by the holding track 25, the ball 23 reciprocates between the protrusions and recessions of the toothed disc 13 and generates repeated impacts on the toothed disc 13 when the scroll wheel 10 is rotated. Thereby, the user will have a hand feeling of discrete vibrations from the scroll wheel 10.

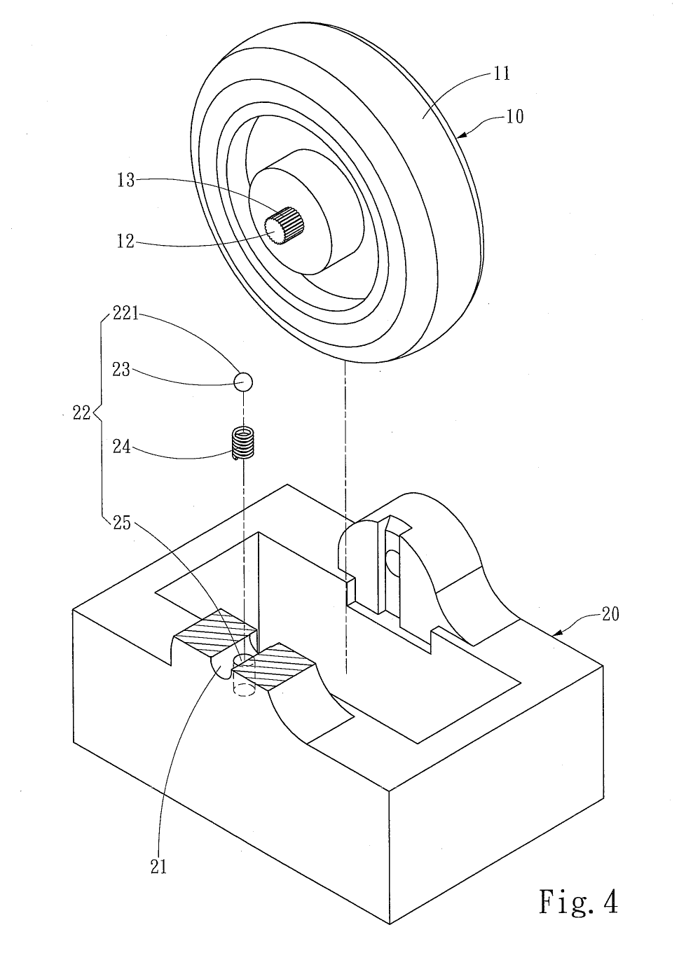

Refer to FIG. 4. In addition to the above-mentioned location, the stepping generation member 22 may also be arranged inside the axle-receiving hole 21. Thereby, the support seat 20 will have more space for other applications.

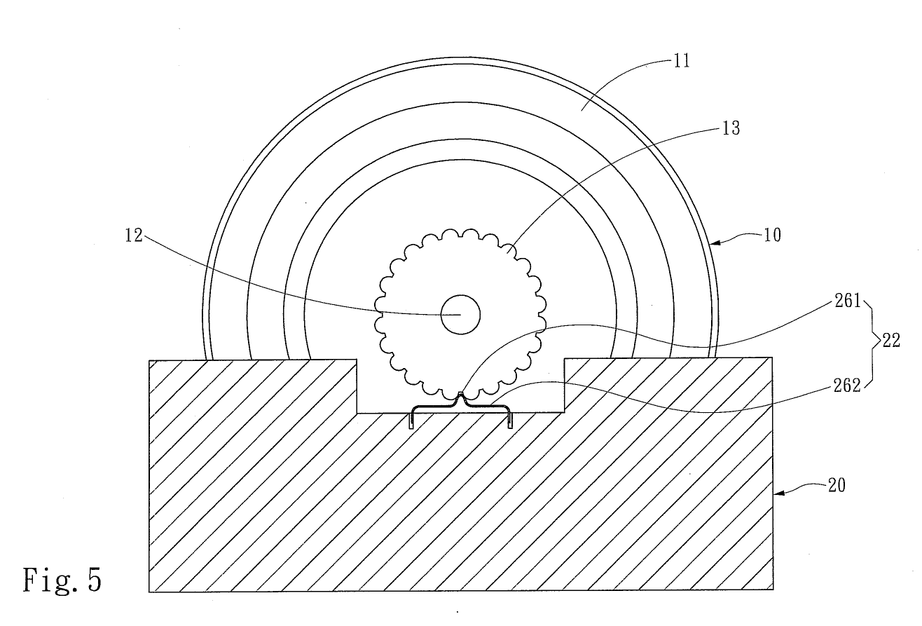

In the present invention, the stepping generation member 22 has many embodiments. Refer to FIG. 5. In this embodiment, the stepping generation member 22 is an elastomer having a pressing tip 261 and a fixing portion 262 fixed to the support seat 20. The elastomer is made of a plastic material or a metallic material. In this embodiment, when the user does not apply any force to the scroll wheel 10, the pressing tip 261 of the elastomer also normally presses against the toothed disc 13. When the rotation of the scroll wheel 10 drives the toothed disc 13 to rotate, the elastic force of the elastomer makes the pressing tip 261 moves to-and-fro between the protrusions and recessions of the toothed disc 13, which forms the vertical and reciprocating vibration travels of the pressing tip 261. Thereby, the user will have a hand feeling of discrete vibrations from the scroll wheel 10.

The present invention incorporates the stepping generation member 22 with the support seat 20 and modularizes the discrete vibration scroll wheel device, whereby the assembling process thereof is simplified, and whereby the components thereof are compactly arranged to reduce the occupied space and promote the space-efficiency of the mouse device. Therefore, the present invention indeed has improvements over the conventional technologies and meets the conditions for a patent. Thus, the Inventor files the application for a patent. It will be appreciated if the patent is approved fast.

The present invention has been described in detail with the embodiments. However, the embodiments described above are only to exemplify the present invention but not to limit the scope of the present invention. Therefore, any equivalent modification or variation according to the spirit of the present invention is to be also included within the scope of the present invention.

What is claimed is:

1. A discrete vibration scroll wheel device, which comprises: a scroll wheel and a support seat supporting the scroll wheel,
wherein said scroll wheel has a wheel portion and an axle portion, and
wherein said support seat has an axle-receiving hole where said axle portion is inserted and held,
characterized in
said axle portion of said scroll wheel has a toothed disc with a plurality of protrusions and recessions arranged alternately, and
said support seat has a stepping generation member corresponding to said toothed disc, and
said stepping generation member has a pressing tip normally contacting said toothed disc, and
rotation of said scroll wheel makes said pressing tip move to-and-fro between said protrusions and said recessions and generates vertical and reciprocating vibration travels of said pressing tip.

2. The discrete vibration scroll wheel device according to claim 1,
wherein said stepping generation member has a ball containing said pressing tip and an elastic member pressing said ball to normally contact said toothed disc.

3. The discrete vibration scroll wheel device according to claim 2,
wherein said ball and said elastic member are installed inside a holding track.

4. The discrete vibration scroll wheel device according to claim 2,
wherein said elastic member is a spring or an elastic rubber.

5. The discrete vibration scroll wheel device according to claim 1,
wherein said stepping generation member is an elastomer having a pressing tip and a fixing portion fixed to said support seat.

6. The discrete vibration scroll wheel device according to claim 1,
wherein said stepping generation member is arranged inside said axle-receiving hole.

7. The discrete vibration scroll wheel device according to claim 6,
wherein said stepping generation member has a ball containing said pressing tip and an elastic member pressing said ball to normally contact said toothed disc.

8. The discrete vibration scroll wheel device according to claim 7,
wherein said ball and said elastic member are installed inside a holding track.

9. The discrete vibration scroll wheel device according to claim 7,
wherein said elastic member is a spring or an elastic rubber.

10. The discrete vibration scroll wheel device according to claim 6,
wherein said stepping generation member is an elastomer having a pressing tip and a fixing portion fixed to said support seat.
